(19) United States
(12) Patent Application Publication
(10) Pub. No.: US 2024/0271830 A1
(43) Pub. Date: Aug. 15, 2024

(54) Geothermal Power Generation System

(71) Applicant: August H. Beck, III, San Antonio, TX (US)

(72) Inventor: August H. Beck, III, San Antonio, TX (US)

(21) Appl. No.: 18/417,951

(22) Filed: Jan. 19, 2024

Related U.S. Application Data
(60) Provisional application No. 63/440,037, filed on Jan. 19, 2023.

(51) Int. Cl. F24T 10/13; F02C 1/05; F24T 50/00

(52) U.S. Cl. CPC F24T 10/13; F02C 1/05; F24T 10/10; F24T 10/17; F24T 10/20; F24T 10/30; F24T 50/00; F24T 2010/53

(57) ABSTRACT

A geothermal power generation system comprising a geothermal water lift and a geothermal power generator is shown. The geothermal water lift comprises a well bore extending from the surface downwardly into the earth, a casing affixed inside to well bore, and a tubing extending downwardly through the casing creating an annulus area in the well bore between the casing and the tubing. Fluid is introduced into the annulus area from the surface and flows downwardly, gaining temperature due the temperature gradient with the surrounding earth, until it reaches an open end of the tubing down hole. The fluid reverses direction into the tubing and begins rising upward toward the surface. The pressure decreases on the fluid as it rises until it reaches critical vapor pressure and begins to boil increasing velocity of the stream. Power is generated at the surface through turbines operably connected to a power generator including through a fluid turbine that utilizes the momentum of the fluid/gas stream.

### CROSS-REFERENCE TO RELATED APPLICATIONS

None.

### STATEMENTS REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

### 1. Field of the Invention

The present invention relates to a method and system for generating geothermal power. More particularly, the present invention relates to a method and system for providing geothermal fluid lift for use in geothermal power generation.

### 2. Description of the Related Art

Geothermal power is electrical power generated from geothermal energy. Geothermal power systems were first developed around 1900 and have been in use in various forms since then. Historically, geothermal electric stations have until recently been built exclusively where high-temperature geothermal resources are available near the surface. Geothermal power is considered to be sustainable because the heat extraction is small compared to the Earth's heat content.

Despite geothermal energy's advantages, numerous barriers—technical, financial, geological, and legal—have hindered the ability to construct a geothermal facility directly supply electricity. For example, the U.S. Navy's geothermal facility at China Lake in California, operational since the 1980s, is the only one of its kind that exists for the military. This facility 1) uses conventional geothermal technology which limits scaling to other installations and 2) the power it produces is exported to the grid and not the installation. The U.S. government has been unable to replicate a similar project anywhere. Although newer geothermal technologies hold the promise of allowing power without relying on hot underground water resources, such technologies do not currently exist at utility-scale. See, Defense Innovation Unit, Geothermal Systems, https://www.diu.mil/work-with-us/submit-solution/PROJ00404.

As shown the example in FIG. 1 shows, geothermal power generation systems exist that utilize heated water extracted through a production well and returned through a second injection well. This diagram shows use of a separate working fluid cycle that is heated by the geothermal energy. The geothermal fluid is then returned to the earth reservoir. The working fluid is cooled after the turbine to return to water for pumping, then brought back to steam through the geothermal boiler. This system requires a water pump to deliver the water from the production well. As will be recognized by a person of skill in the art, it would be advantageous to develop a geothermal water lift system that could provide boiling water/steam vapor for use in geothermal power generation without requiring a second injection well for retuning the water to the formation.

### BRIEF SUMMARY OF THE INVENTION

The present invention is a geothermal power generation system comprising a geothermal water lift and a geothermal power generator. The geothermal fluid lift comprises a well bore extending from the surface downwardly into the earth, a casing affixed inside to well bore, and a tubing extending downwardly through the casing creating an annulus area in the well bore between the casing and the tubing. A fluid such as water is introduced into the annulus area from the surface and flows downwardly through the annulus, gaining temperature due the temperature gradient with the surrounding earth, until the reaches an open end of the tubing down hole. The fluid will reverse direction into the tubing and begin rising back upward toward the surface. The pressure decreases on the fluid as it rises toward the surface until the fluid reaches critical vapor pressure and begins to boil creating a gas and increasing velocity of the fluid/gas stream. In preferred embodiments, the well bore includes a generally vertical portion and a generally horizontal portion, the generally horizontal portion providing dynamic dwell time to allow the water to heat to maximum temperature. Preferably, power is be generated at the surface through turbines operably connected to a power generator including through a fluid turbine that utilizes the momentum of the fluid/gas stream, through an evaporator that uses the heat of the boiling fluid/gas stream to generate a gas stream to drive a turbine, and/or through a boiler that drives a boiling fluid/gas turbine. Preferably, the power generation system utilizes two or more of these means of generating electricity. The spinning of the turbines causes the generators to rotate and thereby generate electricity.

In an alternative embodiment, a first packer is included sealing the annulus area at a first position and fluid is driven into the formation through perforations in the casing above the packer. In this embodiment a second packer seals the annulus area proximate to a termination point of the casing and heated fluid is forced from the formation back up into the tubing.

Additional advantages of the invention are set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

A better understanding of the present invention can be obtained when the following detailed description of the disclosed embodiments is considered in conjunction with the following drawings in which:

FIG. 1 is an elevation view of a prior art geothermal power generation system;

FIG. 2 is an elevation view of an embodiment of a geothermal water lift;

FIG. 3 is an elevation view of an embodiment of geothermal power generator system;

FIG. 4 is a process flow diagram of another embodiment of power generation system; and

FIG. 5 is an elevation view of an alternative embodiment of the down hole portion of the system.

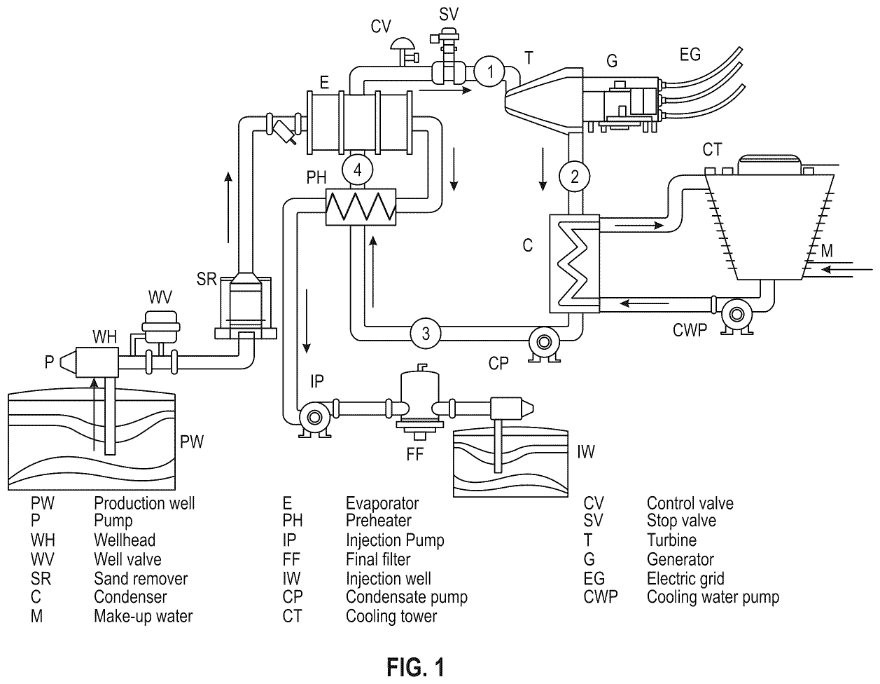

### DETAILED DESCRIPTION OF THE INVENTION

The present invention is a geothermal power generation system comprising a geothermal water lift and a geothermal power generator. The geothermal water lift comprises a well bore extending from the surface downwardly into the earth, a casing affixed inside to well bore, and a tubing extending downwardly through the casing creating an annulus area in the well bore between the casing and the tubing. Water would be introduced into the annulus area from the surface and flows downwardly through the annulus, gaining temperature due the temperature gradient with the surrounding earth, until the reaches an open end of the tubing down hole. The water will reverse direction into the tubing and begin rising back upward toward the surface. The pressure decreases on the water as it rises toward the surface until the water reaches critical vapor pressure and begins to boil creating steam and increasing velocity of the water/vapor stream. In preferred embodiments, the well bore includes a generally vertical portion and a generally horizontal portion, the generally horizontal portion providing dynamic dwell time to allow the water to heat to maximum temperature. The horizontal portion of the well bore does not have to be truly horizontal. As a person of ordinary skill in the art will recognize, the horizontal portion of a well bore is typically parallel with the reservoir formation. Preferably, power is be generated at the surface through turbines operably connected to a power generator including through a fluid turbine that utilizes the momentum of the fluid/gas stream, through an evaporator that uses the heat of the boiling fluid/gas stream to generate a gas stream to drive a turbine, and/or through a boiler that drives a boiling fluid/gas turbine. Preferably, the power generation system utilizes two or more of these means of generating electricity. The spinning of the turbines causes the generators to rotate and thereby generate electricity. In an alternative embodiment, a first packer is included sealing the annulus area at a first position and fluid is driven into the formation through perforations in the casing above the packer. In this embodiment a second packer seals the annulus area proximate to a termination point of the casing and heated fluid is forced from the formation back up into the tubing.

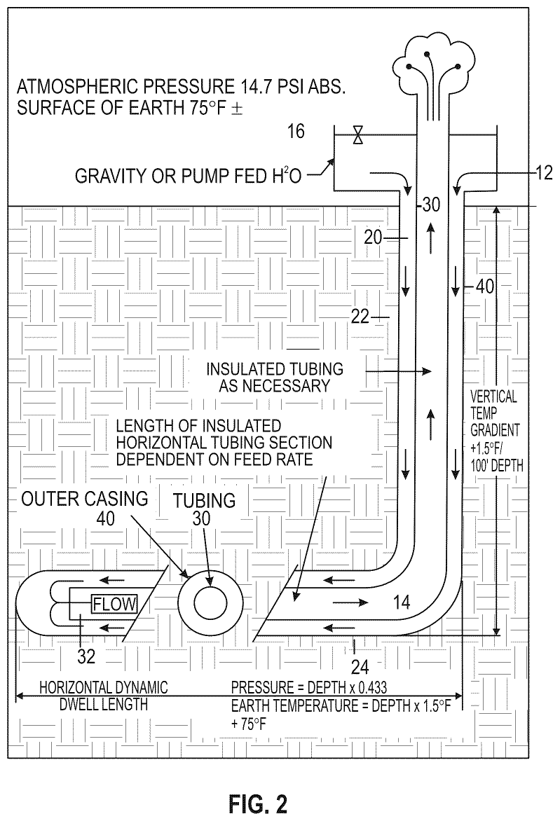

As shown in FIG. 2, in one embodiment the water stream 12 is fed into the top of the vertical annulus 20 between casing 40 and tubing 30 and gains heat as it descends because of earth's increasing temperature gradient. As will now be recognized by a person of skill in the art, water stream 12 may comprise other fluids that can be headed in the system. Well bore 10 may include a generally vertical section 22 and a generally horizontal section 24. As will now be recognized by a person of skill in the art, the well bore may have other configurations including but not limited to a generally vertical well bore, a slanted well bore, or any combination of shapes as are known to those skilled in the art. Additionally, when utilizing a previously existing or abandoned oil and gas well, there may be perforations in the existing well casing. In these cases, the perforations could be sealed off with, for example, cement or a liner could be installed.

In this embodiment, as the water stream 20 enters horizontal section 24, it will continue to gain heat until it reaches the temperature of the earth at that depth. The horizontal length of annulus 20 (dwell length) utilized to bring up the heat to maximum temperature is dependent on water temperature when entering horizontal section 24, flow rate and volume of water in annulus 20.

Preferably, tubing 30 is uninsulated as should be acceptable depending upon the overall conditions in the well. Alternatively, tubing 30 inserted through the well casing 40 could be insulated until the water stream 12 reaches maximum temperature to prevent heat loss from the rising heated water stream 14. The rising water stream 14 will be at maximum temperature when it enters the open termination end 32 of the tubing 30 and will reverse its path across the horizontal section 24. The end length of the tubing 30 can be uninsulated until the temperature of the annulus water stream 12 is less than maximum temperature.

As the water stream in the tubing 14 rises in the vertical section 22, the pressure in the tubing 30 will decrease because the weight in the fluid column will be decreasing. Also, other factors will affect the pressure in the tubing 30 like flow rate in tubing 30. As the pressure decreases and the temperature remains near maximum, the water steam 14 will reach critical vapor pressure and begin to boil creating steam vapor. The expanding vapor will increase the velocity of the fluid stream 14 more and more as the fluid level gets closer and closer to atmospheric pressure.

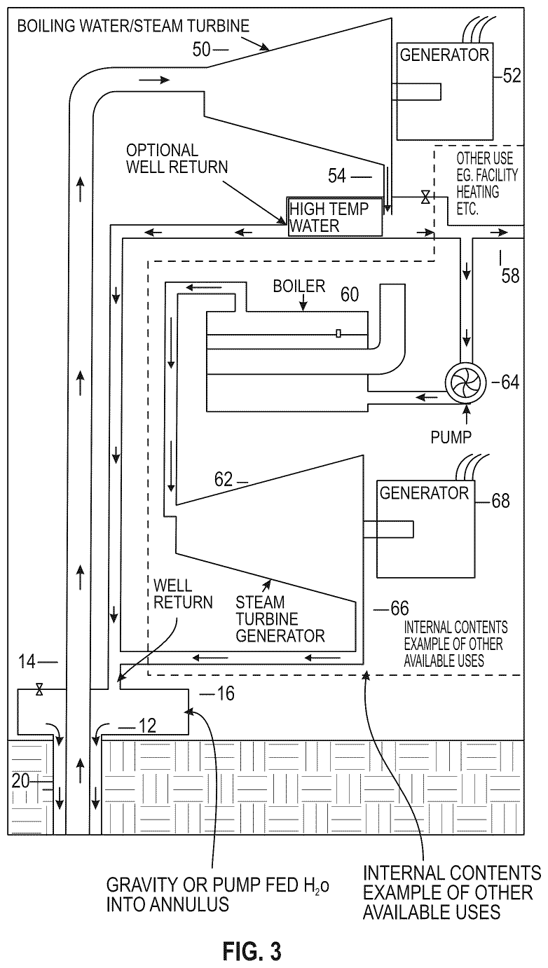

As shown in FIG. 3, in one embodiment this higher velocity boiling water/steam vapor stream 14 will enter the fluid turbine 50 and cause it to spin. The spinning turbine 50 will spin the generators 62 that creates electricity—a true geothermal example of geothermal electrical generation. The fluids 54 exhausting from the turbine 50 can be returned to the entry of the annulus 20 and be reheated to close the cycle (closed loop). Alternatively, the fluids 54 exiting the turbine 50 can be used for other purposes such as facility heating 58. Fluids 54, still at high temperature, can also be pumped into a boiler 60 where it is heated by burning fuel to turn fluids stream 54 into steam (gas) for a steam turbine 62 to drive additional electrical generation or other uses.

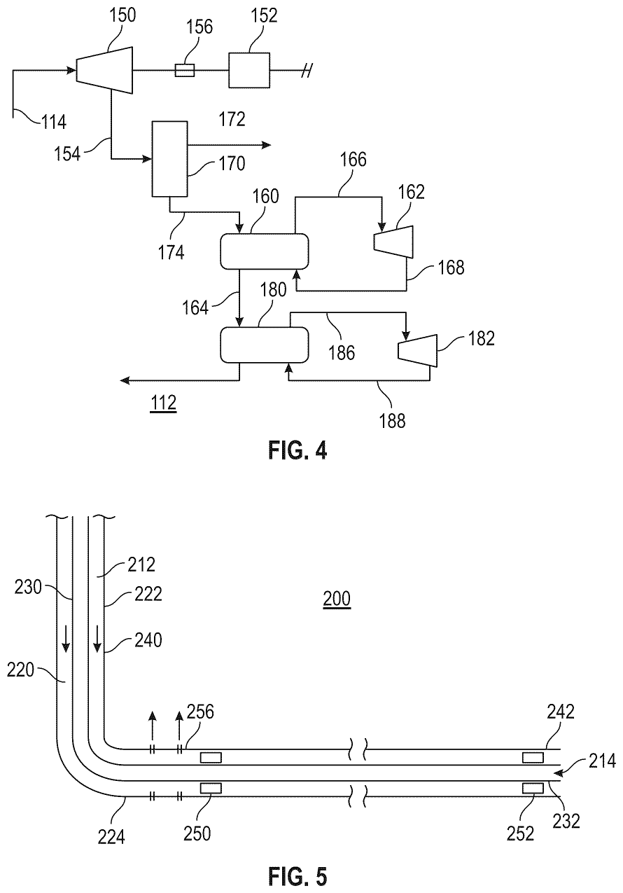

As shown in FIG. 4, the surface power generation system can comprise several different configurations. In this embodiment, like the embodiment of FIG. 3, the rising fluid/gas stream 114 enters fluid turbine 150 and the fluid/gas stream 114 momentum drives the turbine 152 which in turn drives power generator 152 to generate electricity. In this embodiment, The stream 154 exits the turbine 150 can be run through and optional separator 170 to separate oil and or gas 172 out of the fluid and the remaining stream 174 which retains substantial heat can be utilized as the heat source for evaporator 160 to vaporize another fluid stream 168, preferably water, into steam stream 166 which is used to drive a steam turbine 162 to generate additional power. Water stream 168 then exits the turbine and is recirculated to evaporator 150. As will now be recognized by one skilled in the art, additional heat can be added to evaporator 160 by utilizing an accompanying boiler (not shown) to vaporize the recirculating water stream 168. The fluid stream 164 exiting the evaporator 160 can optionally be utilized in a combination evaporator/boiler 180 to vaporize fluid, preferably water, stream 188 into steam 186 that can drive an additional steam turbine 182 for additional power generation. Alternatively, fluid stream 164 can be directly heated in a boiler 180′ to vaporize at least a portion of stream 164 to directly drive steam turbine 182. Stream 112 exiting the evaporator/boiler 180 is returned to the annulus 20 inside the well bore for reuse.

The cost of drilling a 12,000 ft. deep hole with a 4,000 to 10,000 ft. horizontal lateral, for example, is very expensive. As recognized by a person of skill in the art, these dimensions are exemplary and would depend upon the well conditions, dimensions of the well components, etc. It would be advantageous to repurpose played out horizontal oil and gas wells. The well bore could be cemented off across the perforations to seal off the producing formation. The cement in the well bore could then be drilled out making the well bore suitable for the geothermal use. Depending on casing diameter, it might be necessary to cement a liner in the casing across the perforations to help effect a seal. Oilfield practices will dictate the diameter of casing in any one field and could limit the capacity of boiling water/steam (electricity) that could be produced from a single oil well. The lower cost, however, would be advantageous so it should be acceptable to have multiple wells feeding multiple turbines rather than one big more costly new well. Redundancy would also be advantageous and intelligent.

As shown in FIG. 5, in an alternate embodiment, reservoir 200 can be utilized to heat fluid stream 212. In this embodiment, a well packer 250 would be placed inside the annulus 220 between the casing 240 and tubing 230 along the well bore to block further fluid flow along annulus 220. By way of a non-limiting example, well packer 250 could be place about 25% into the length of the horizontal section of the well bore. A second well packer 252 is placed in the annulus area 220 near the terminal end 242 of the well casing 240 to block flow into the annulus at the terminal end 242. The portion of the annulus area 220 between well packer 250 and well packer 252 would be a dead space with no flow. Instead, perforations 256 along casing 230 before well packer 250 would allow fluid stream 212 out of the annulus and into reservoir 200. Although FIG. 5 shows use of a well bore with both a horizontal section 224 and a vertical section 222, the well bore could be entirely vertical or include a sloping section as well. The addition of fluid stream 212 to the reservoir would push fluids, including water if fluid steam 212 is water, along with residual oil and gas from the reservoir 200 as stream 214 into the open end 232 of the tubing 230. Stream 214 would rise as described above and be utilized to generate power through fluid turbines 50 or 150. Preferably, when this embodiment is utilized, oil and gas separator 170 is also utilized to remove oil and gas from the recirculating fluid system. This embodiment not only provides heated stream 214 as a source to drive turbines and generate power, but it also recovers additional oil and gas from the original well.

As used herein, the term “about,” when referring to a value or to an amount of a dimension, area, percentage, etc., is meant to encompass variations of in some embodiments plus or minus 20%, in some embodiments plus or minus 10%, in some embodiments plus or minus 5%, in some embodiments plus or minus 1%, in some embodiments plus or minus 0.5%, and in some embodiments plus or minus 0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter. With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, S, C, and/or O” includes A, S, C, and O individually, but also includes any and all combinations and subcombinations of A, S, C, and O.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. The foregoing disclosure and description are illustrative and explanatory thereof, and various changes in the details of the illustrated apparatus and construction and method of operation may be made without departing from the spirit in scope of the invention which is described by the following claims.

We claim:

1. An geothermal water lift method comprising the steps of:
providing a well bore extending from a surface generally downwardly into earth;
providing a well casing insert into and affixed to a length of the well bore;
providing a tubing inserted into and through the well casing forming an annulus area between the well casing and the tubing;
introducing a fluid stream into the annulus area proximate to the surface, the fluid stream flowing down the well bore through the annulus area between the casing and tubing and being heated by a temperature gradient with the earth thereby forming a heated fluid stream;
allowing the heated fluid stream to enter inside the tubing at a termination end of the tubing and flow generally upwardly toward the surface, a decreasing pressure on the heated water stream creating formation of fluid vapor thereby creating a boiling fluid/gas vapor stream having a higher velocity at the surface that at the termination end of the tubing;
providing a boiling fluid/vapor turbine at the surface;
providing an electricity generator operably connected to the fluid/vapor turbine;
introducing the boiling fluid/gas vapor stream into the turbine thereby causing the turbine to rotate and to discharge a residual heated fluid stream;
allowing the rotation of the turbine to drive the electricity generator thereby creating electricity.

2. The method of claim 1 further comprising the steps of
providing a boiler to heat the residual heated stream;
providing a gas turbine;
heating the residual heated fluid stream in the boiler to generate a gas vapor stream; and
utilizing the gas vapor stream to drive the steam turbine.

3. The method of claim 1 further comprising the steps of
providing an evaporator to heat a recirculating fluid stream;
providing a gas turbine;
utilize the residual heated fluid stream in the evaporator to generate a gas vapor stream from the recirculating fluid stream by heating the recirculating fluid stream; and
utilizing the gas vapor stream to drive the steam turbine.

4. The method of claim 3 wherein additional heat is added to the residual heated fluid stream by combining a fueled boiler with the evaporator.

5. The method of claim 3 further comprising the steps of providing a boiler and a second gas turbine;
introducing the residual heated fluid stream exiting the evaporator into a fuel fired boiler;
heating the residual heated fluid stream to a temperature that generates a second gas vapor stream; and
utilizing the second gas vapor stream to drive the second steam turbine.

6. The method of claim 5 wherein the second gas stream is generated directly the residual heated fluid stream by vaporizing at least a portion of that residual heated fluid stream.

7. The method of claim 5 wherein the second gas stream is generated by using the heat of the residual heated fluid stream and a fuel in the boiler to heat a second isolated recirculating fluid stream and vaporizing at least a portion of that second isolated recirculating fluid stream.

8. The method of claim 1 wherein the well bore utilized is from a preexisting oil and gas well.

9. The method of claim 1 wherein the well bore includes a horizontal portion extending generally parallel to the surface.

10. The method of claim 1 wherein the fluid streams comprise water.

11. The method of claim 1 further comprising the steps of:
providing a first and second well packer;
utilizing the first well packer to seal off flow through the annulus area at a point after the well bore enters a reservoir formation;
utilizing the second well packer to seal off flow through the annulus area near a termination point of the well bore;
providing perforations in the well bore above the first well packer; and
introducing the fluid stream flowing down the well bore into the reservoir formation through the perforations;
wherein the heated fluid stream entering the tubing originates in the reservoir formation.

12. The method of claim 1 further comprising the steps of:
providing an oil and gas separator vessel;
introducing the residual heated fluid stream into the oil and gas separator to remove oil and gas from the residual heated fluid stream.

13. An geothermal water lift method comprising the steps of:
providing a well bore extending from a surface generally downwardly into earth;
providing a well casing insert into and affixed to a length of the well bore;
providing a tubing inserted into and through the well casing forming an annulus area between the well casing and the tubing;
providing a first and second well packer;
utilizing the first well packer to seal off flow through the annulus area at a point after the well bore enters a reservoir formation;
utilizing the second well packer to seal off flow through the annulus area near a termination point of the well bore;
providing perforations in the well bore above the first well packer; and
introducing a fluid stream into the annulus area proximate to the surface, the fluid stream flowing down the well bore through the annulus area between the casing and tubing and being heated by a temperature gradient with the earth thereby forming a heated fluid stream;
introducing the fluid stream flowing down the well bore into the reservoir formation through the perforations;
allowing the heated fluid stream originating in the reservoir formation to enter inside the tubing at a termination end of the tubing and flow generally upwardly toward the surface, a decreasing pressure on the heated water stream creating formation of fluid vapor thereby creating a boiling fluid/gas vapor stream having a higher velocity at the surface that at the termination end of the tubing;
providing a boiling fluid/vapor turbine at the surface;
providing an electricity generator operably connected to the fluid/vapor turbine;
introducing the boiling fluid/gas vapor stream into the turbine thereby causing the turbine to rotate and to discharge a residual heated fluid stream;
allowing the rotation of the turbine to drive the electricity generator thereby creating electricity.

14. The method of claim 13 further comprising the steps of
providing an evaporator to heat a recirculating fluid stream;
providing a gas turbine;
utilize the residual heated fluid stream in the evaporator to generate a gas vapor stream from the recirculating fluid stream by heating the recirculating fluid stream; and
utilizing the gas vapor stream to drive the steam turbine.

15. The method of claim 14 wherein additional heat is added to the residual heated fluid stream by combining a fueled boiler with the evaporator.

16. The method of claim 14 further comprising the steps of providing a boiler and a second gas turbine;
introducing the residual heated fluid stream exiting the evaporator into a fuel fired boiler;
heating the residual heated fluid stream to a temperature that generates a second gas vapor stream; and
utilizing the second gas vapor stream to drive the second steam turbine.

17. The method of claim 16 wherein the second gas stream is generated directly the residual heated fluid stream by vaporizing at least a portion of that residual heated fluid stream.

18. The method of claim 16 wherein the second gas stream is generated by using the heat of the residual heated fluid stream and a fuel in the boiler to heat a second isolated recirculating fluid stream and vaporizing at least a portion of that second isolated recirculating fluid stream.

19. The method of claim 1 further comprising the steps of:
providing an oil and gas separator vessel;
introducing the residual heated fluid stream into the oil and gas separator to remove oil and gas from the residual heated fluid stream.
